(19) United States
(12) Patent Application Publication
(10) Pub. No.: US 2013/0057692 A1
(43) Pub. Date: Mar. 7, 2013

(54) STORE SYSTEM AND METHOD

(71) Applicants: Hidehiro Naito, Shizuoka-ken (JP); Masato Watabe, Shizuoka-ken (JP); Masahide Ogawa, Shizuoka-ken (JP); Shinji Nakatake, Shizuoka-ken (JP)

(72) Inventors: Hidehiro Naito, Shizuoka-ken (JP); Masato Watabe, Shizuoka-ken (JP); Masahide Ogawa, Shizuoka-ken (JP); Shinji Nakatake, Shizuoka-ken (JP)

(73) Assignee: TOSHIBA TEC KABUSHIKI KAISHA, Tokyo (JP)

(21) Appl. No.: 13/604,784

(22) Filed: Sep. 6, 2012

(30) Foreign Application Priority Data
Sep. 6, 2011 (JP) 2011-194003

(51) Int. Cl. H04N 7/18

(52) U.S. Cl. 348/150; 348/E07.085

(57) ABSTRACT

A store system comprises an acquisition section configured to acquire an image picked-up by an image pick-up section, a similarity calculation section configured to calculate a similarity which represents a degree with which the reference image of each commodity is similar to the image of an object picked-up by the image pick-up section, a display control section configured to display the commodity information of the commodity corresponding to the reference image with a high similarity as a commodity candidate executing registration processing on a display section based on the similarity calculated by the similarity calculation section, a selection acceptance section configured to accept the selection to the commodity information displayed on the display section and a processing section configured to process the object picked-up by the image pick-up section as the commodity corresponding to the selected commodity information accepted by the selection acceptance section.

### CROSS-REFERENCE TO RELATED APPLICATION

This application is based upon and claims the benefit of priority from Japanese Patent Application No. 2011-194003, filed Sep. 6, 2011, the entire contents of which are incorporated herein by reference.

### FIELD

Embodiments described herein relate to a store system and a method.

### BACKGROUND

Formerly, a generic object recognition technology existed, the characteristic quantity of a target is extracted from the image data of a picked-up article, and the category and the like of the article are recognized (detected) by comparing the extracted characteristic quantity with previously prepared data (characteristic quantity) for check. Moreover, a system for utilizing the generic object recognition technology to differentiate the category of foods and the like is further provided.

### BRIEF DESCRIPTION OF THE DRAWINGS

FIG. 1 is a perspective drawing showing one example of a checkout system (store system) of an embodiment;

FIG. 2 is a block diagram showing hardware compositions of a POS terminal and a commodity reading apparatus;

FIG. 3 is a conceptual diagram exemplifying a data composition of a PLU file;

FIG. 4 is a block diagram showing function compositions of the POS terminal and the commodity reading apparatus;

FIG. 5 is a flow chart showing one example of the actions of the checkout system of the present embodiment;

FIG. 6 is a conceptual graph showing an example of a reading region of a reading window;

FIG. 7 is a flow chart showing one example of the actions of commodity candidate prompt processing;

FIG. 8 is a drawing showing one example of the relationship between a similarity and a commodity image;

FIG. 9 is a drawing showing one example of the grouping of the commodity images;

FIG. 10 is a drawing showing one example of a displayed screen displayed on a display of the commodity reading apparatus;

FIG. 11 is a drawing showing one example of the displayed screen displayed on the display of the commodity reading apparatus;

FIG. 12 is a drawing showing one example of the displayed screen displayed on the display of the commodity reading apparatus;

FIG. 13 is a drawing showing one example of the displayed screen displayed on the display of the commodity reading apparatus; and

FIG. 14 is a drawing showing other examples of the displayed screen displayed on the display of the commodity reading apparatus.

### DETAILED DESCRIPTION

According to one embodiment, a store system comprises an acquisition section configured to acquire an image picked-up by an image pick-up section, a similarity calculation section configured to calculate a similarity which represents a degree with which the reference image of each commodity is similar to the image of an object picked-up by the image pick-up section, a display control section configured to display the commodity information of the commodity corresponding to the reference image with a high similarity as a commodity candidate executing registration processing on a display section based on the similarity calculated by the similarity calculation section, a selection acceptance section configured to accept the selection to the commodity information displayed on the display section and a processing section configured to process the object picked-up by the image pick-up section as the commodity corresponding to the selected commodity information accepted by the selection acceptance section.

Hereinafter, the store system and a method of the present embodiment are described with reference to schemas by taking a checkout system for example. The store system is the checkout system (POS system) and the like comprising a POS terminal carrying out the registration and the check computation of the commodity of one deal. The present embodiment is an application example for the checkout system introduced into a store such as a supermarket and the like.

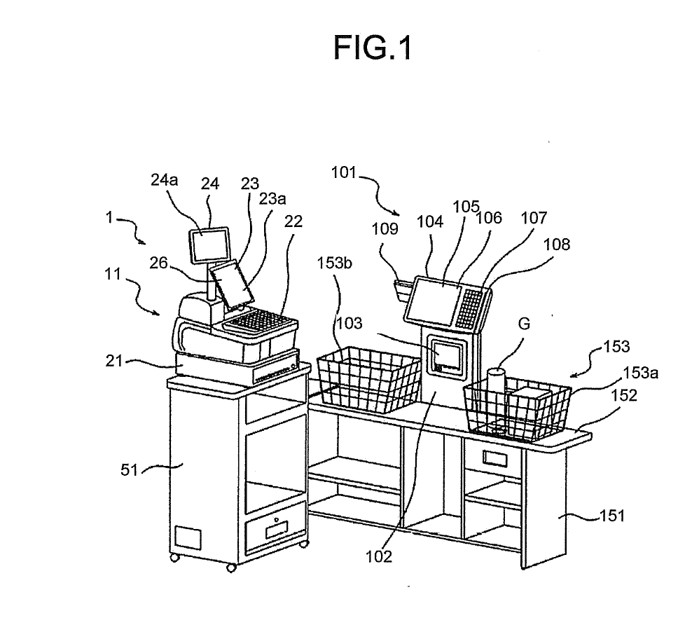

FIG. 1 is a perspective drawing showing one example of the checkout system 1. As shown in FIG. 1, the checkout system 1 comprises the POS terminal 11 carrying out the registration and the check computation of the commodity of one deal. The POS terminal 11 is borne on the upper surface of a cash drawer 21 of a settlement platform 51. The opening action of the cash drawer 21 is controlled by the POS terminal 11. The upper surface of the POS terminal 11 is equipped with a keyboard 22 pressed down and operated by an operator (salesclerk). Observed from one side of the operator operating the keyboard 22, a display 23 displaying the information towards the operator is arranged at the more inner side of the keyboard 22. The display 23 displays the information on its display surface 23a. A touch panel 26 is laminated on the display surface 23a. A customer-oriented display 24 freely rotated is vertically arranged at the innermost side of the display 23. The customer-oriented display 24 displays the information on its display surface 24a. In addition, according to the customer-oriented display 24 shown in FIG. 1, the display surface 24a faces to an approximately front side in FIG. 1, the display surface 24a is enabled to face to an inner side in FIG. 1 by rotating the customer-oriented display 24, and the customer-oriented display 24 displays the information towards a customer.

A counter 151 in the shape of a transverse long table is configured in the way of forming an L character with the settlement platform 51 bearing the POS terminal 11. A goods receiving surface 152 is formed on the upper surface of the counter 151. A shopping basket 153 containing a commodity G is borne on the goods receiving surface 152. The shopping baskets 153 can be considered to be divided into a first shopping basket 153a held by the hands of the customer and a second shopping basket 153b borne at a position clamping a commodity reading apparatus 101 with the first shopping basket 153a. In addition, the shopping basket 153 is not limited to the shape of a basket and also can be a tray and the like. Moreover, the shopping basket 153 (the second shopping basket 153b) is not limited to the shape of the basket and further can be box-shaped, bag-shaped and the like.

The commodity reading apparatus 101 connected with the POS terminal 11 in the way of being capable of receiving and sending data is arranged on the goods receiving surface 152 of the counter 151. The commodity reading apparatus 101 comprises a thin rectangular housing 102. A reading window 103 is configured on the front surface of the housing 102. A display/operating section 104 is mounted at the upper part of the housing 102. The display/operating section 104 is equipped with a display 106, on the surface of which a touch panel 105 is laminated. A keyboard 107 is arranged on the right side of the display 106. A card reading slot 108 of a card reader which is not shown in figures is arranged on the right side of the keyboard 107. Observed from one side of the operator, a customer-oriented display 109 for providing the information for the customer is arranged near the left inner side of the back surface of the display/operating section 104.

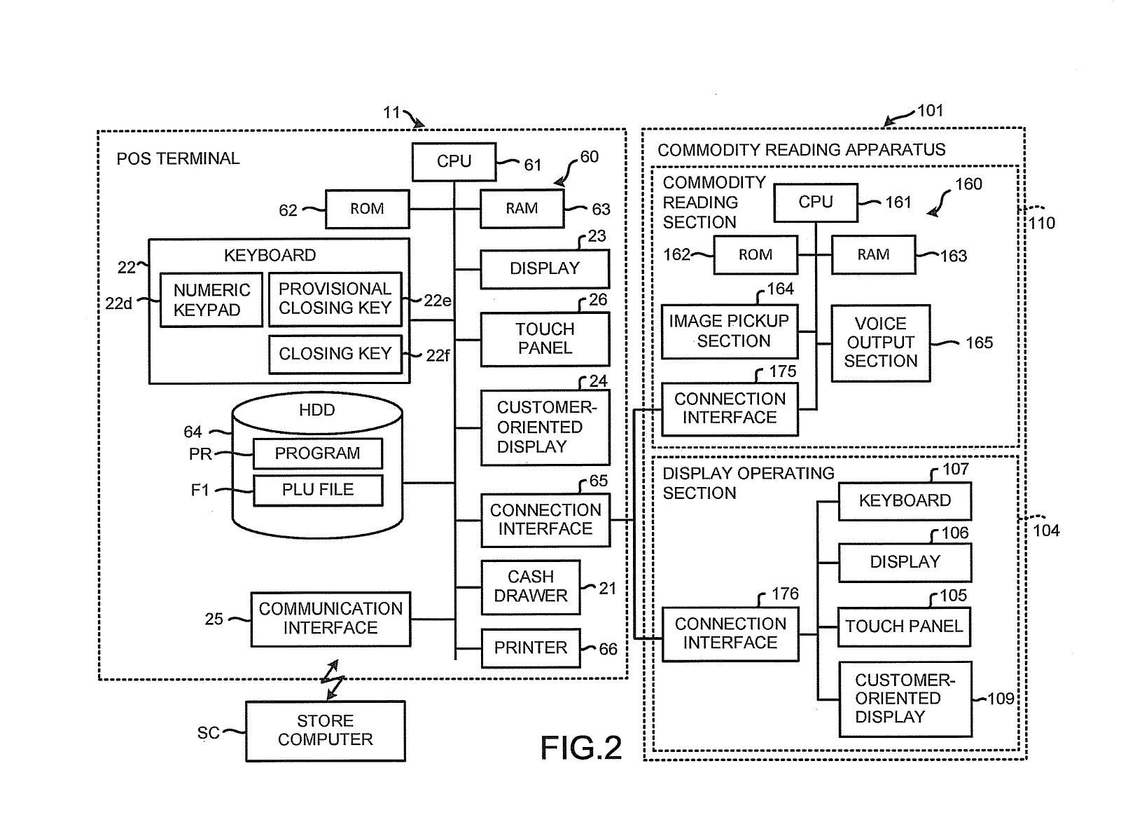

The commodity reading apparatus 101 comprises a commodity reading section 110 (referring to FIG. 2). The commodity reading section 110 is equipped with a image pick-up section 164 (referring to FIG. 2) at the inner side of the reading window 103.

The commodity G of one deal is contained in the first shopping basket 153a held by the hands of the customer. The commodity G in the first shopping basket 153a is moved into the second shopping basket 153b by the operator operating the commodity reading apparatus 101. In the movement process, the commodity G is enabled to face to the reading window 103 of the commodity reading apparatus 101. At this moment, the image pick-up section 164 (referring to FIG. 2) configured in the reading window 103 shoots the commodity G.

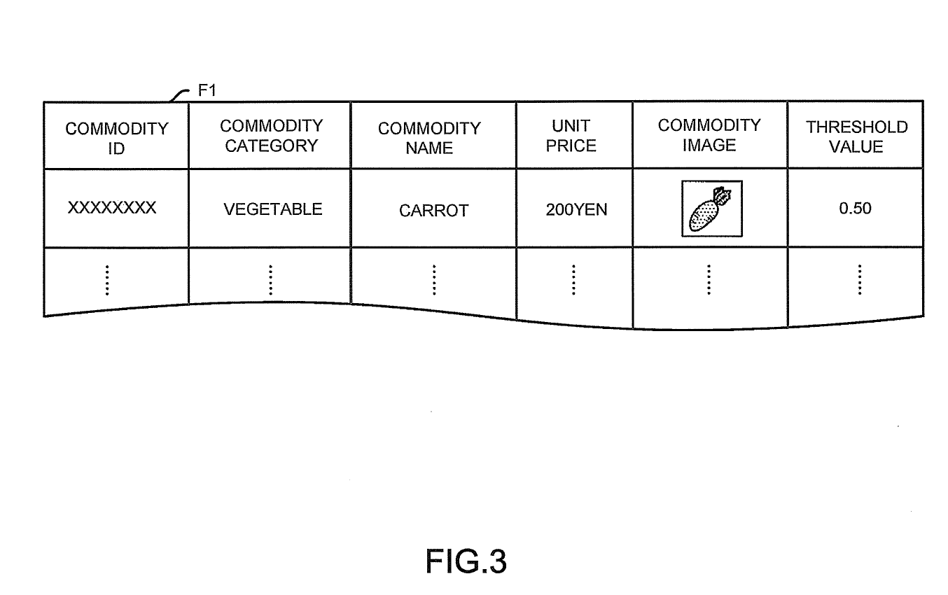

In the commodity reading apparatus 101, a screen for appointing the commodity G included in the image picked-up by the image pick-up section 164 and corresponding to the commodity registered in the following PLU file F1 (referring to FIG. 3) is displayed on the display/operating section 104, and the commodity ID of the appointed commodity is notified to the POS terminal 11. In the POS terminal 11, sales registration information such as the commodity classification, the commodity name, the unit price and the like of the commodity corresponding to the commodity ID is recorded in a sales master file (not shown in the figures) and the like to carry out sales registration based on the commodity ID notified from the commodity reading apparatus 101.

FIG. 2 is a block diagram showing hardware compositions of the POS terminal 11 and the commodity reading apparatus 101. The POS terminal 11 comprises a microcomputer 60 as an information processing section executing information processing. The microcomputer 60 is formed by connecting an ROM 62 (Read Only Memory) and an RAM 63 (Random Access Memory) onto a CPU 61 (Central Processing Unit) executing various calculation processing and further controlling all sections by buses.

The CPU 61 of the POS terminal 11 is connected with the cash drawer 21, the keyboard 22, the display 23, the touch panel 26 and the customer-oriented display 24 through various input and output circuits (all not shown in the figures). These construction members are controlled by the CPU 61.

The keyboard 22 includes a numeric keypad 22d, the upper surface of which displays numerals such as “1”, “2”, “3” . . . and the like and a multiplication operational character such as “x”, a provisional closing key 22e and a closing key 22f.

The CPU 61 of the POS terminal 11 is connected with an HDD 64 (Hard Disk Drive). The program and various files are stored in the HDD 64. All or part of the program and the various files stored in the HDD 64 are copied to the RAM 63 and are executed in sequence by the CPU 61 when the POS terminal 11 is started up. One example of the program stored in the HDD 64 is a program PR for processing commodity sales data. One example of the files stored in the HDD 64 is the PLU file F1 sent from a store computer SC and stored.

The PLU file F1 is the file set to establish relevance for the information of the sales registration of the commodity G and the image of the commodity G aiming at each commodity G exhibited and sold in the store.

FIG. 3 is a conceptual graph exemplifying a data composition of the PLU file F1. As shown in FIG. 3, the PLU file F1 is the file which stores the information relevant with the commodity, such as the uniquely distributed commodity ID, the commodity classification to which the commodity G belongs, the commodity name, the unit price and the like, the commodity image obtained by image pick-up the commodity and a threshold value “similarity: 0.XX” as the commodity information of the commodity G aiming at each commodity G. Detailed description is described hereinafter, and in the conditions that the commodity G is a fruit, a raw or fresh product and the like and further changes color and the like due to the decrement of a freshness, the threshold value “similarity: 0.XX” can be used for judging that the commodity G is an article different from a standard state by being compared with the commodity image of the commodity previously stored in the PLU file F1. In addition, the PLU file F1 is constituted to be capable of being read out (reference) by the commodity reading apparatus 101 through a connection interface 65.

In addition, the data composition of the PLU file F1 is not limited to the example in FIG. 3, for instance, the form further can be that the following characteristic quantities (color, surface concave-convex status and the like) of each commodity, which can be read from the commodity image are related to store.

In FIG. 2, the CPU 61 of the POS terminal 11 is connected with the store computer SC and a communication interface 25 for executing data communication through the input and output circuits (not shown in the figures). The store computer SC is arranged at a backyard and the like of the store. The PLU file F1 sent to the POS terminal 11 is stored in the HDD (not shown in the figures) of the store computer SC.

In addition, the CPU 61 of the POS terminal 11 is connected with the connection interface 65 capable of receiving and sending the data with the commodity reading apparatus 101. The connection interface 65 is connected with the commodity reading apparatus 101. Moreover, the CPU 61 of the POS terminal 11 is connected with a printer 66 printing a receipt and the like. The POS terminal 11 prints the deal contents of one deal on the receipt based on the control of the CPU 61.

The commodity reading apparatus 101 further comprises a microcomputer 160. The microcomputer 160 is formed by connecting an ROM 162 and an RAM 163 onto a CPU 161 by buses. The program executed by the CPU 161 is stored in the ROM 162. The CPU 161 is connected with the image pick-up section 164 and a voice output section 165 through various input and output circuits (all not shown in the figures). The actions of the image pick-up section 164 and the voice output section 165 are controlled by the CPU 161. The display/operating section 104 is connected to the commodity reading section 110 and the POS terminal 11 through a connection interface 176. The action of the display/operating section 104 is controlled by the CPU 161 of the commodity reading section 110 and the CPU 61 of the POS terminal 11.

The image pick-up section 164 is a camera COD image sensor or a camera CONS image sensor and the like, and is the image pick-up section carrying out image pick-up from the reading window 103 under the control of the CPU 161. For instance, the image pick-up section 164 carries out the image pick-up of a 30 fps of dynamic image. The image pick-up section 164 stores frame images (picked-up images) which are picked-up in sequence with a specified frame rate in the RAM 163.

The voice output section 165 is a voice circuit, a loudspeaker and the like for generating a preset warning tone and the like. The voice output section 165 carries out reporting by voices such as the warning tone and the like under the control of the CPU 161.

In addition, the CPU 161 is connected with a connection interface 175, and the connection interface 175 is connected with the connection interface 65 of the POS terminal 11 and can receive and send the data with the POS terminal 11. Moreover, the CPU161 receives and sends the data with the display/operation section 104 through the connection interface 175.

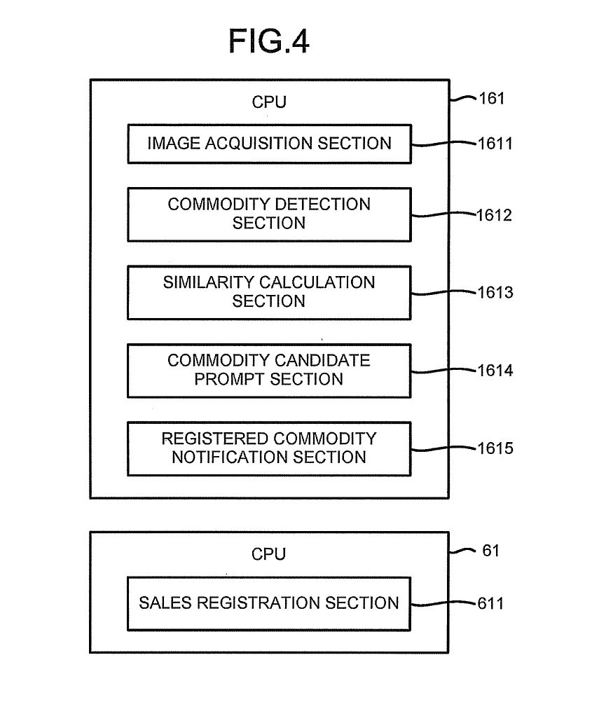

Next, functional sections of the CPU 161 and the CPU 61 realized by executing the program in sequence by the CPU 161 and the CPU 61 are described with reference to FIG. 4.

FIG. 4 is a block diagram showing function compositions of the POS terminal 11 and the commodity reading apparatus 101. As shown in FIG. 4, the CPU 161 of the commodity reading apparatus 101 exerts functions as an image acquisition section 1611, a commodity detection section 1612, a similarity calculation section 1613, a commodity candidate prompt section 1614 and a registered commodity notification section 1615 by executing the program in sequence. Moreover, similarly, the CPU 61 of the POS terminal 11 exerts the functions as a sales registration section 611.

The image acquisition section 1611 outputs a image pick-up-on signal to the image pick-up section 164, so that the image pick-up section 164 begins a image pick-up action. The image acquisition section 1611 acquires the frame images stored in the RAM 163 after being picked-up by the image pick-up section 164 in sequence after the image pick-up action begins. The image acquisition section 1611 acquires the frame images according to a storage sequence in the RAM 163.

The commodity detection section 1612 detects all or part of the articles such as the commodities G and the like included in the frame images acquired by the image acquisition section 1611 by utilizing a pattern matching technology and the like. Particularly, contour lines and the like are extracted from the images obtained by carrying out binaryzation on the acquired frame images. Subsequently, the contour line extracted from the nearest frame image is compared with that extracted from the present frame image to detect a part with alteration, namely the mapping into of the articles including the commodities G which face to the reading window 103 for carrying out the sales registration.

In addition, as other methods for detecting the included commodity, the existence of a skin color region is detected according to the acquired frame images. Subsequently, in the condition that the skin color region is detected, namely in the condition that the mapping into of the hands of the salesclerk and the like is detected, a contour including the commodity supposed to be held by the hands of the salesclerk and the like is tentatively extracted by detecting the contour line. At this moment, in the condition that the contour representing a hand shape and other contours are detected, as the salesclerk holds the commodity by the hands, the mapping into of the included commodity is detected.

The similarity calculation section 1613 reads surface states such as the colors, the surface concave-convex statuses and the like of the commodities G from all or part of the images of the commodities G picked-up by the image pick-up section 164 of the commodity reading apparatus 101 as the characteristic quantities. In addition, in order to shorten processing time, the similarity calculation section 1613 does not consider the contour and the size of the commodity G.

Moreover, the similarity calculation section 1613 reads the surface states such as the color, the surface concave-convex status and the like of the registered commodity from the commodity image of each commodity (called as registered commodity hereinafter) registered in the PLU file F1 as the characteristic quantities, and calculates the similarity of the commodity G and the commodity registered in the PLU file F1 by comparing the read characteristic quantities with the characteristic quantities of the commodity G. Herein, the similarity represents the degree with which all or part of the images of the commodity G are similar in the condition that the commodity image of each commodity stored in the PLU file F1 is set to be 100%=“similarity: 1.0”. As described above, for instance, the similarity is calculated according to the surface states such as the color, the surface concave-convex status and the like. In addition, for instance, weighting further can be added in the color and the surface concave-convex status.

Moreover, the similarity calculation section 1613 judges whether or not the calculated similarity of each registered commodity exceeds the preset threshold value (“similarity: 0.XX”) of the commodity, and recognizes (judges) the registered commodity, the similarity of which exceeds the threshold value, as a candidate (called as commodity candidate hereinafter) of the commodity G. In addition, in the condition that the characteristic quantities of each commodity image are related and stored in the PLU file F1, it further can be the form of carrying out comparison by utilizing the characteristic quantities stored in the PLU file F1.

The method for recognizing the object included in the image is normally called as generic object recognition. About the generic object recognition, various recognition technologies are explicated in the following document.

Yanai Keiji, “present state and perspectives of generic object recognition”, collected papers of information processing society, Vol. 48, No. SIG16 [retrieved on Heisei August10,22],Internet <URL:http://mm.cs.uec.ac.jp/IPSJ-TCVIM-Yanai.pdf>.

Moreover, a technology for the generic object recognition by carrying out region segmentation on the image according to a target is explicated in the following document.

Jamie Picked-upton and the like, “Semantic Texton Forests for Image Categorization and Segmentation”, [retrieved on Heisei August10,22],Internet <URL:http://citeseerx.ist.psu.edu/viewdoc/download?doi=10.1.1.145.3036&rep=rep1&type=pdf>.

In addition, the method for calculating the similarity of the image of the picked-up commodity G and the commodity image of the registered commodity registered in the PLU file F1 is not particularly limited. For instance, the similarity of the image of the picked-up commodity G and each registered commodity registered in the PLU file F1 can be calculated as absolute evaluation and also can be calculated as relative evaluation.

In the condition that the former calculation method is used, the image of the picked-up commodity G is compared with each registered commodity registered in the PLU file F1 one to one, and the educed similarity after a comparison result is directly adopted. Moreover, in the condition that the latter calculation method is used, for instance, if five registered commodities (commodities GA, GB, GC, GD and GE) are registered in the PLU file F1, the calculation method is as follows: the similarities of the picked-up commodity G are 0.6 relative to the commodity GA, 0.1 relative to the commodity GB, 0.1 relative to the commodity GC, 0.1 relative to the commodity GD, 0.1 relative to the commodity GE and the like, and the sum of the similarities relative to each registered commodity is 1.0 (100%).

However, the condition that a plurality of commodity candidates are recognized can exist in the recognition result of the similarity calculation section 1613 sometimes. Therefore, based on the recognition result of the similarity calculation section 1613, in the condition that a plurality of registered commodities as the commodity candidate exist, the commodity candidate prompt section 1614 reads out the commodity images of the registered commodities from the PLU file F1, and displays the commodity images in sequence on the display 106 according to a fixed number from the commodity image with the highest similarity calculated by the similarity calculation section 1613. In addition, the display processing about the commodity image is described hereinafter.

Moreover, if the commodity candidate prompt section 1614 accepts the selection to one commodity image from the commodity images displayed by the display 106 through the touch panel 105, the registered commodity of the selected commodity image is judged to correspond to the commodity G. Subsequently, the commodity candidate prompt section 1614 outputs the information (such as the commodity ID, the commodity name, the image file name of the selected commodity image and the like) indicating the registered commodity to the registered commodity notification section 1615.

In addition, in the present embodiment, in the condition that the commodity candidate is a single registered commodity, the registered commodity is regarded as the commodity G, the form of the commodity image display of the registered commodity is omitted, but not limited to this, it also can be the form of requiring the operator to confirm by displaying the commodity image on the display 106. Moreover, in the present embodiment, it is the form that the commodity candidate prompt section 1614 displays the commodity image on the display 106; however, other commodity information also can be displayed; for instance, literal information such as the commodity name, the commodity price and the like can be only displayed; and moreover, the literal information and the commodity image further can be displayed correspondingly.

The registered commodity notification section 1615 notifies the commodity ID corresponding to the registered commodity indicated by the commodity candidate prompt section 1614 and a sales number additionally input through the touch panel 105 or the keyboard 107 together to the POS terminal 11. In addition, the notification of the commodity ID can be in the form that the registered commodity notification section 1615 directly notifies the commodity ID read out from the PLU file F1, can be in the form of notifying the file name of the commodity image capable of specifying the commodity ID and the commodity name, and further can be in the form of notifying the storage location (storage address in the PLU file F1) of the commodity ID to the POS terminal 11.

The sales registration section 611 carries out the sales registration of the corresponding commodity based on the commodity ID and the sales number notified by the registered commodity notification section 1615. Particularly, the sales registration section 611 records the notified commodity ID, the commodity classification, the commodity name, the unit price and the like corresponding to the commodity ID and the sales number together in the sales master file with reference to the PLU file F1 and the like, so as to carry out the sales registration.

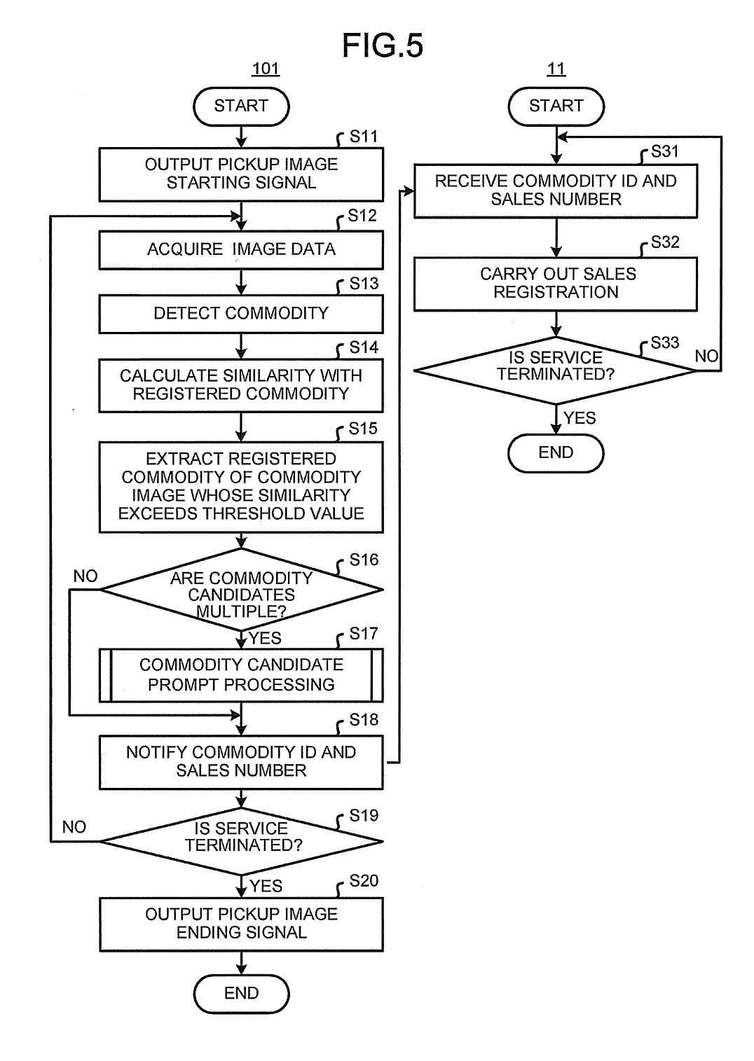

Next, the actions of the checkout system 1 are described in detail. FIG. 5 is a flow chart showing one example of the actions of the checkout system 1 of the present embodiment.

First, the actions on the side of the commodity reading apparatus 101 are described. As shown in FIG. 5, if the POS terminal 11 begins processing according to the beginning of the commodity registration and the like, the image acquisition section 1611 outputs the image pick-up-on signal to the image pick-up section 164, and the image pick-up section 164 begins image pick-up (act S11).

The image acquisition section 1611 acquires the frame images (picked-up images) stored in the RAM 163 after being picked-up by the image pick-up section 164 (act S12). Subsequently, the commodity detection section 1612 detects all or part of the commodities G from the frame images acquired by the image acquisition section 1611 (act S13). Subsequently, the similarity calculation section 1613 reads the characteristic quantities of the commodities G from all or part of the images of the commodities G, and calculates the similarity by comparing the read characteristic quantities with the characteristic quantities of each commodity image registered in the PLU file F1 (act S14).

Subsequently, the similarity calculation section 1613 judges whether or not the calculated similarity of each registered commodity exceeds the preset threshold value (“similarity: 0.XX”) of the commodity, and extracts the registered commodity, the similarity of which exceeds the threshold value, as the commodity candidate of the commodity G (act S15).

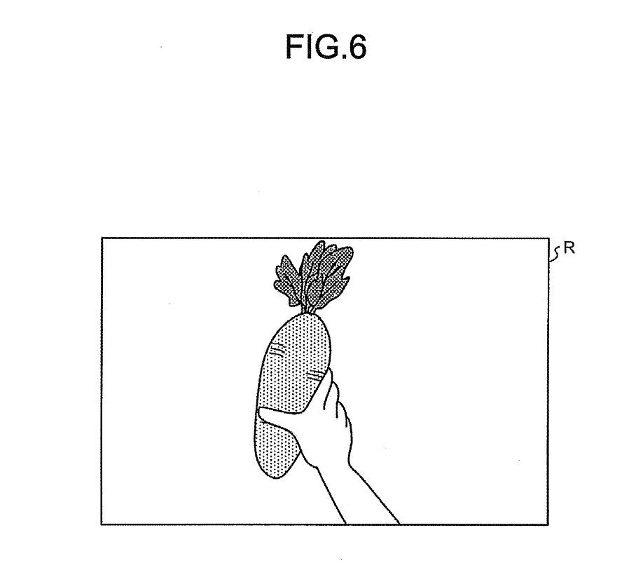

FIG. 6 is a conceptual graph showing an example of a reading region R of the reading window 103. Particularly, FIG. 6 is the conceptual graph exemplifying the reading region R when the commodity G is read. As shown in FIG. 6, in the condition that the commodity G is mapped into the reading region R in the movement process of the commodity G, all or part of the commodities G are detected from the frame image obtained by image pick-up the reading region R in act S13. By the detection of all or part of the commodities G, the recognition of the commodities G is carried out in act S14.

Subsequently, the commodity candidate prompt section 1614 judges whether or not the number of the recognized commodity candidates (registered commodities) is multiple in act S15 (act S16). Herein, in the condition that the number of the registered commodity set as the commodity candidate is judged to be one (act S16; No), the commodity candidate prompt section 1614 judges that the registered commodity corresponds to the commodity G. Afterwards, the commodity candidate prompt section 1614 outputs the information indicating the registered commodity and the sales number additionally input together to the registered commodity notification section 1615, and turn to act S18.

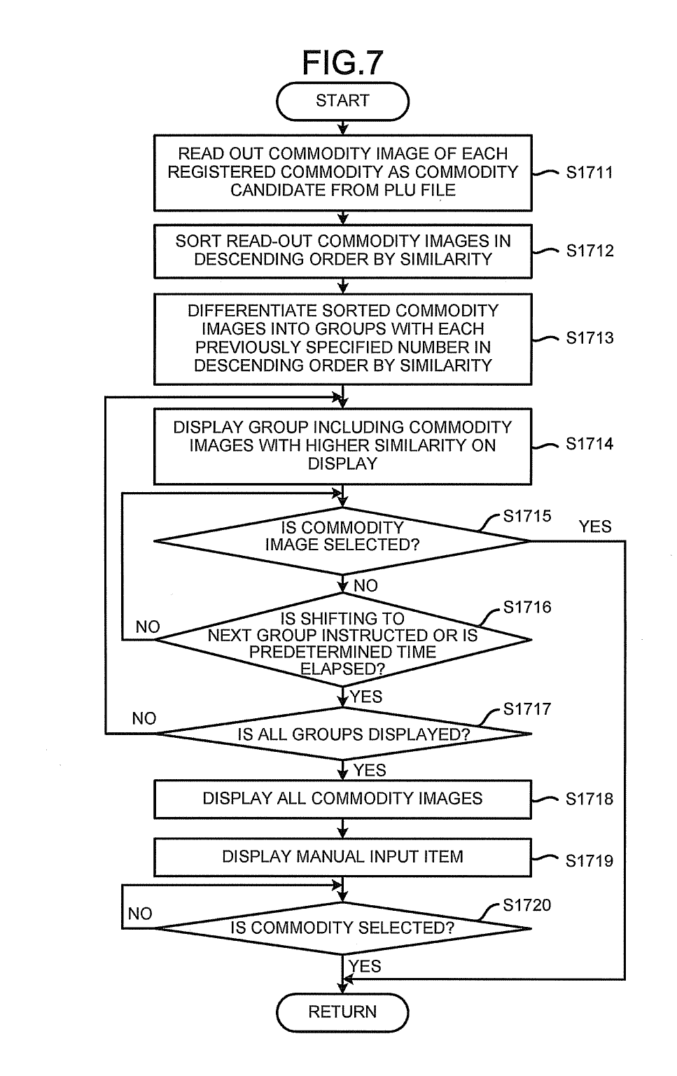

On the other hand, in the condition that the number of the commodity candidates (registered commodities) is judged to be multiple (act S16; Yes), the commodity candidate prompt section 1614 turns to commodity candidate prompt processing in act S17. Hereinafter, the actions of the commodity candidate prompt processing in act S17 are described with reference to FIG. 7.

FIG. 7 is a flow chart showing one example of the actions of the commodity candidate prompt processing. First, the commodity candidate prompt section 1614 reads out the commodity image of each registered commodity set as the commodity candidate from the PLU file F1 (act S1711). Subsequently, the commodity candidate prompt section 1614 sequences a plurality of commodity images read out in act S1711 according to the similarities sorted in S14 from high ones to low ones (act S1712). Subsequently, the commodity candidate prompt section 1614 carries out group-based differentiation on the commodity images with a preset number according to the sequence from the high similarity to the low similarity based on display number set information (act S1713).

Herein, the “display number set information” is set information specifying a display form when the commodity image read out in act S1711 is displayed on the display 106, and is previously stored in a storage medium such as the ROM 162 of the commodity reading apparatus 101, the HDD64 of the POS terminal 11 and the like. The composition number of the commodity images in each group is specified in the display number set information when, for instance, the commodity images are differentiated (grouped) according to the sequence from the high similarity to the low similarity. As one example, in the condition that the differentiation is carried out with three groups of “1, 3, 3” according to the sequence from the high similarity to the low similarity is specified in the display number set information, the commodity candidate prompt section 1614 differentiates one commodity image with the highest similarity as a first group, differentiates three commodity images with a secondly high similarity, a thirdly high similarity and a fourthly high similarity as a second group, and differentiates three commodity images with a fifthly high similarity, a sixthly high similarity and a seventhly high similarity as a third group.

In addition, in the condition that a plurality of commodity images with the same similarity exist, the number of the commodity images is added to carry out the differentiation. Moreover, a description method and a set content in the display number set information are not limited to the above-described example, for instance, it further can be set to carry out the differentiation on each two commodity images according to the sequence from the high similarity to the low similarity, and the like. Moreover, it further can be in the form of setting the similarity of 1.00-0.90 into one group, the similarity of 0.90-0.80 into another group and the like to carry out the differentiation based on the value of the similarity.

Subsequently, the commodity candidate prompt section 1614 selects the group including the commodity images with higher commodity in sequence from the groups differentiated in act S1713, and displays the commodity images included in the selected group on the display 106 (act S1714).

Subsequently, the commodity candidate prompt section 1614 judges which one is selected from the commodity images displayed on the display 106 through the touch panel 105 or the keyboard 107 (act S1715). Herein, in the condition that one commodity image is judged to be selected (act S1715; Yes), the commodity candidate prompt section 16614 judges that the registered commodity corresponding to the selected commodity image corresponds to the commodity G, outputs the information indicating the registered commodity to the registered commodity notification section 1615, and then turns to act S18 in FIG. 5.

On the other hand, in the condition that no commodity is judged to be selected (act S1715; No), the commodity candidate prompt section 1614 judges whether or not to indicate to turn to a next group through the touch panel 105 and the keyboard 107, or judges whether or not fixed time (such as 5 seconds and the like) passes after the commodity image is displayed in the nearest act S1713 (act S1716). In addition, in the condition that any requirement is not met in act S1716 (act S1716; No), the processing returns to act S1715 again.

In act S1716, in the condition that indicating to turn to the next group is judged or the fixed time passes (act S1716; Yes), the commodity candidate prompt section 1614 judges whether or not all the groups are displayed (act S1717). Herein, in the condition that the group which is not displayed is judged to still exist (act S1717; No), the processing returns to act S1714 again, and the group which is not displayed is regarded as a display target.

In act S1717, in the condition that all the groups are judged to be displayed (act S1717; Yes), the commodity candidate prompt section 1614 displays all the commodity images read out in act S1711 on the display 106 (act S1718), and further displays an operational character (called as manual input item hereinafter) for manually inputting the appointment of the registered commodity corresponding to the commodity G on the display 106 (act S1719). In addition, the commodity image removed from the groups in act S1713 is further included in the commodity images displayed in act S1718. Moreover, the display sequence of each commodity image is not limited, for instance, the display sequence can be in accordance with the sequence from the high similarity to the low similarity and also can be in accordance with the sequence from the low similarity to the high similarity.

Subsequently, the commodity candidate prompt section 1614 is standby until one registered commodity is selected based on the commodity image and the manual input item displayed on the display 106 (act S1720; No). Subsequently, if one registered commodity is judged to be selected through the touch panel 105 or the keyboard 107 (act S1720: Yes), the commodity candidate prompt section 1614 judges that the selected registered commodity corresponds to the commodity G, outputs the information indicating the registered commodity to the registered commodity notification section 1615, and then turns to act 518 in FIG. 5.

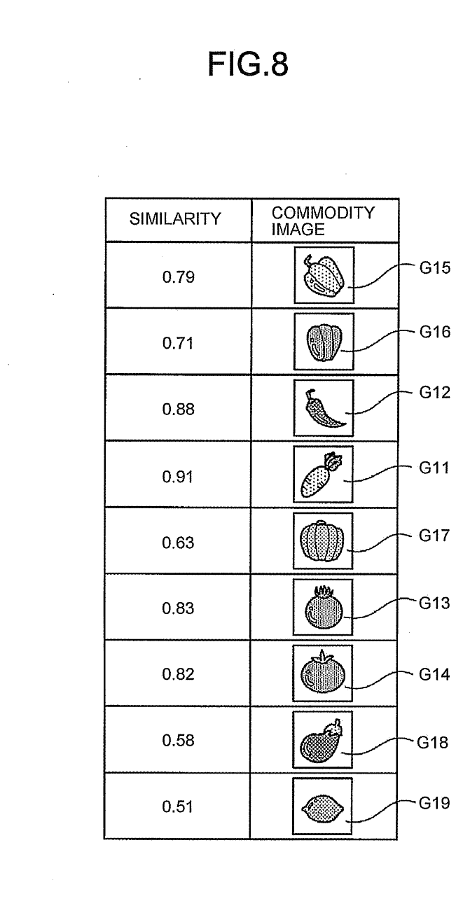

Herein, the actions of the commodity candidate prompt processing are described with reference to FIG. 6 and FIG. 8-FIG. 13. For instance, aiming at the commodity G (carrot) shown in FIG. 6, the similarity of the commodity G with nine commodity images G11-G19 shown in FIG. 8 is judged to exceed the preset threshold value (each registered commodity is set to be “similarity: 0.50” herein.) by the similarity calculation section 1613, and the commodity candidate prompt section 1614 reads out the nine commodity images G11-G19 from the PLU file F1 in act S1711. In addition, in FIG. 8, the similarity calculated by the similarity calculation section 1613 and the relationship with the commodity image are related and represented.

Next, the commodity candidate prompt section 1614 sequences the commodity images read out from the PLU file F1 according to the sequence from the high similarity to the low similarity in act S1712 of the commodity candidate prompt processing. Afterwards, the commodity candidate prompt section 1614 continuously differentiates the sequenced commodity images into one group or a plurality of groups including the commodity images with the fixed number based on the display number set information in act S1713.

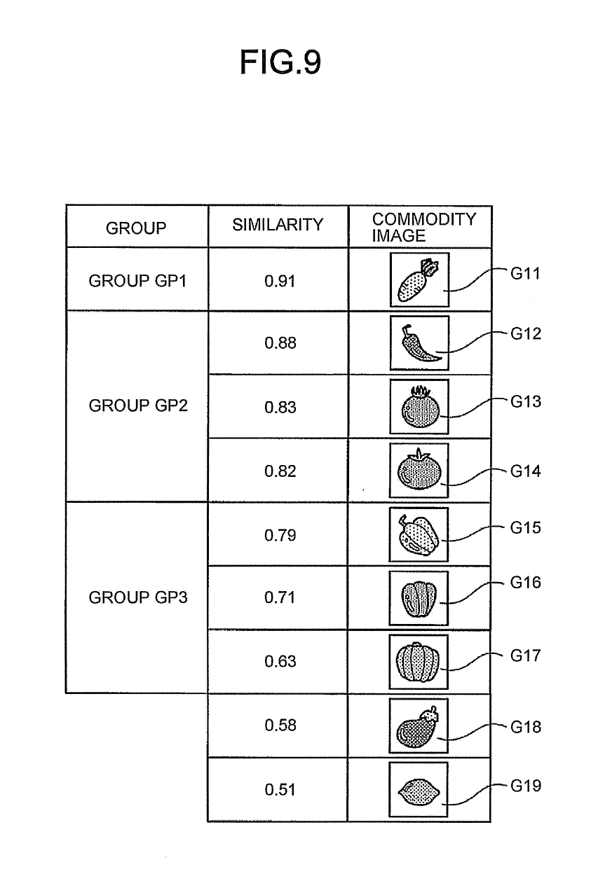

Herein, for instance, the differentiation of the three groups of “1, 3, 3” according to the sequence from the high similarity to the low similarity is set in the display number set information, the commodity candidate prompt section 1614 differentiates the nine commodity images G11-G19 shown in FIG. 8 into three groups (groups GP1, GP2 and GP3) shown in FIG. 9. In addition, about the commodity images G18 and G19, as they are out the application range of the display number set information, they do not belong to any groups.

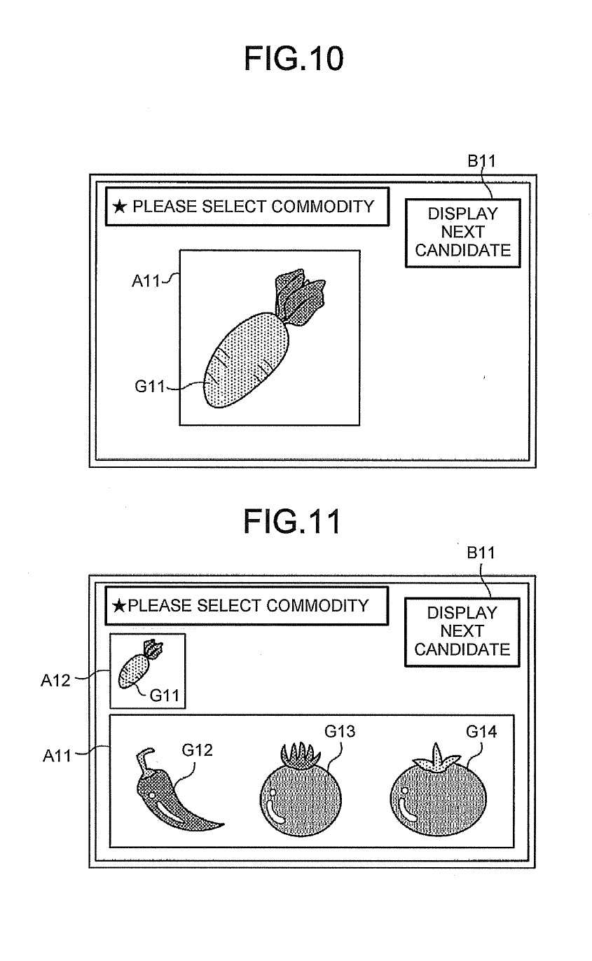

Next, the commodity candidate prompt section 1614 selects the group GP1 including the commodity images with the higher similarity in act S1714, and displays one commodity image G11 included in the group GP1 on the touch panel 105 (referring to FIG. 10).

FIG. 10 is a drawing showing one example of a displayed screen displayed on the display 106. A region A11 is a display region for displaying the commodity images included in the group selected in the nearest act S1714. In the same figure, an example that the group GP1 shown in FIG. 9 is selected in the nearest act S1714 is shown, and the commodity image G11 included in the group GP1 is displayed in the region A11. Moreover, a button B11 is an operation button for indicating to display the next group.

Herein, if the operator selects (touches) the commodity image G11 displayed in the region A11, the commodity candidate prompt section 1614 outputs the information indicating the registered commodity of the selected commodity image G11 to the registered commodity notification section 1615 (act S1715; Yes)

On the other hand, in the state that the commodity image G11 is not selected and in the condition that the operation to the button B11 is accepted, or in the condition that the fixed time passes from the display of the commodity image G11 in the region A11 (act S1715; No-pact S1716; Yes), the commodity candidate prompt section 1614 judges that the group which is not displayed exists in act S1717 (act S1717; No). Afterwards, the commodity candidate prompt section 1614 returns to act S1714 again, selects the “group GP2” as the next group, and displays three commodity images G12-G14 included in the group GP2 on the display 106 (referring to FIG. 11)

FIG. 11 is a drawing showing one example of the displayed screen displayed on the display 106. In FIG. 11, the group GP2 is selected in the nearest act S1714, and therefore, the commodity images G12-G14 included in the group GP2 are displayed in the region A11. Moreover, a region A12 is a display region for displaying the commodity images displayed in the region A11 until a last time as historic records. In FIG. 11, the commodity image G11 of the group GP1 displayed in the region A11 last time is displayed in the region A12.

Herein, if the operator selects any one of the commodity images G11-G14 displayed in the region A11 and the region A12, the commodity candidate prompt section 1614 outputs the information indicating the selected commodity image to the registered commodity notification section 1615 (act S1715; Yes).

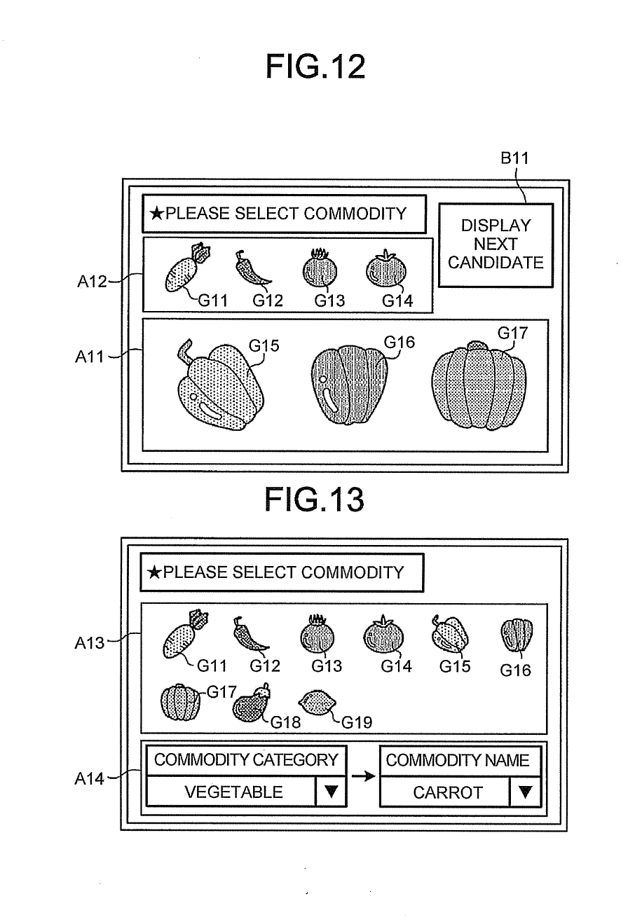

On the other hand, in the state that the commodity images G11-G14 are all not selected and in the condition that the operation to the button B11 is accepted, or in the condition that the fixed time passes from the display of the commodity images G12-G14 in the region A11 (act S1715; No, act S1716; Yes), the commodity candidate prompt section 1614 judges that the group which is not displayed exists in act S1717 (act S1717; No). Afterwards, the commodity candidate prompt section 1614 returns to act S1714 again, selects the “group GP3” as the next group, and displays three commodity images G15-G17 included in the group GP3 on the touch panel 105 (referring to FIG. 12).

FIG. 12 is a drawing showing one example of the displayed screen displayed on the display 106. In FIG. 12, the group GP3 is selected in the nearest act S1714, and therefore, the commodity images G15-G17 included in the group GP3 are displayed in the region A11. Moreover, the commodity images G11-G14 displayed in the region A11 until the last time are displayed in the region A12 as the historic records.

Herein, if the operator selects any one of the commodity images G11-G17 displayed in the region A11 and the region A12, the commodity candidate prompt section 1614 outputs the information indicating the selected commodity image to the registered commodity notification section 1615 (act S1715; Yes).

On the other hand, in the state that the commodity images G11-G17 are all not selected and in the condition that the operation to the button B11 is accepted, or in the condition that the fixed time passes from the display of the commodity images G15-G17 in the region A11 (act S1715; No, act S1716; Yes), the commodity candidate prompt section 1614 judges that the display of all the group has been terminated in act S1716 (act S1717; Yes). Afterwards, the commodity candidate prompt section 1614 displays all the commodity images and the manual input item (referring to FIG. 13) on the display 106 by executing acts S1718 and S1719.

FIG. 13 is a drawing showing one example of the displayed screen displayed on the display 106. A region A13 is a display region for generally viewing and displaying the commodity images. In the same figure, the commodity images G11-G19 read out in act S1711 are displayed in the region A13 according to the sequence (the sequence of a sequencing result shown in FIG. 9) from the high similarity to the low similarity. In addition, in the region A13, when the number of the commodity images which can be displayed is limited, it can be in the form of displaying the commodity images with an upper-limit-value quantity, and further can be in the form of displaying all the commodity images on a plurality of pages by setting a page turning button and the like.

Moreover, in FIG. 13, a region A14 is a display region for displaying the manual input item. In the same figure, as a selection item for reducing the commodities, items such as the commodity classification, the commodity name and the like of the commodity which can be selected are displayed, and one commodity can be selected by selecting the items in sequence. The manual input item is mainly used for the condition that the commodity image corresponding to the commodity G does not exist in the region A13. In addition, the composition of the manual input item is not limited to the example, for instance, the manual input item further can be constituted to be capable of inputting the commodity price.

Herein, if the operator selects any one of the commodity images G11-G19 displayed in the region A13 as one commodity by selecting the manual input item displayed in the region A14, the commodity candidate prompt section 1614 outputs the information indicating the appointed commodity image (commodity) to the registered commodity notification section 1615 (act S1720; Yes).

In this way, in the commodity candidate prompt section 1614, the commodity images of the registered commodities similar to the picked-up commodities G are prompted to the operator with each fixed number according to the sequence from the high similarity to the low similarity. Moreover, if the commodity candidate prompt section 1614 accepts the selection of the commodity image through the touch panel 105 and the like, the registered commodity corresponding to the commodity image is judged to correspond to the commodity G. Therefore, the operator of the commodity reading apparatus 101 can appoint the registered commodity corresponding to the commodity G by selecting one commodity image from the commodity images prompted with each fixed number, and therefore, the selection of the commodity can be carried out effectively.

In FIG. 5, the registered commodity notification section 1615 notifies the commodity ID corresponding to the registered commodity indicated by the commodity candidate prompt section 1614 and the sales number additionally input through the touch panel 105 or the keyboard 107 together to the POS terminal (act S18). Herein, the input of the sales number is carried out through the touch panel 105 and the operation section 104, but an input method is not limited particularly, for instance, the touch times to the commodity image displayed by the display 106 further can be set to be the sales number.

Subsequently, the CPU 161 judges whether or not the POS terminal 11 gives out commodity registration termination notification and the like to terminate a service (act S19) In the condition of continuing the service (act S19; No), the CPU 161 returns the processing to act S12 and continuously carries out the processing. In the condition of terminating the service (act S19; Yes), the image acquisition section 1611 outputs a image pick-up-off signal to the image pick-up section 164 and terminates the image pick-up of the image pick-up section 164 (act S20), so as to terminate the processing.

Next, the actions on the side of the POS terminal 11 are described. As shown in FIG. 6, if the processing begins according to the beginning of the commodity registration and the like caused by the operation indication of the keyboard 22, the CPU 61 receives the commodity ID and the sales number of the commodity G notified from the commodity reading apparatus 101 (act S31).

Subsequently, the sales registration section 611 reads out the commodity category, the unit price and the like from the PLO file F1 based on the commodity ID and the sales number received in act S31, and carries out the sales registration of the commodity G read by the commodity reading apparatus 101 (act S32).

Subsequently, the CPU 61 judges whether or not to terminate the service by the termination of the sales registration caused by the operation indication of the keyboard 22 and the like (act S33). In the condition of continuing the service (act S33; No), the CPU 61 returns to act S31 again to carry out the processing. In the condition of terminating the service (act S33; Yes), the CPU 61 terminates the processing.

As described above, according to the checkout system 1 of the present embodiment, by utilizing the registered commodities with high similarity with the commodities G, the commodity images of the registered commodities are prompted with each fixed number on the display 106. Therefore, the operator of the commodity reading apparatus 101 can select the commodity corresponding to the commodity G picked-up by the image pick-up section 164 from the commodity images displayed with each fixed number according to the sequence from the high similarity to the low similarity, and therefore, the selection of the registered commodity corresponding to the commodity G can be carried out effectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, in the above-described embodiment, the form that the commodity reading apparatus 101 shoots the commodities G one by one is described, but the number of the commodities G picked-up once is not particularly limited and can be multiple. In the condition of image pick-up a plurality of commodities G once, the form is constituted to be capable of selecting one commodity G as a registered target from the commodities G to carry out the recognition of one commodity G selected through the touch panel 105 and the display of the commodity image by displaying the picked-up images of the image pick-up section 164 on the display 106. Moreover, it further can be the following form of recognizing the commodities G once and displaying the commodity images from the commodity image with the high similarity based on the recognition result. In addition, in the condition of the form, the following composition for the following purpose is comprised, namely, by carrying out the operations such as the selection of the commodity image after one commodity G included in the picked-up image is selected and the like, the commodity G included in the picked-up image and the selected commodity image are related.

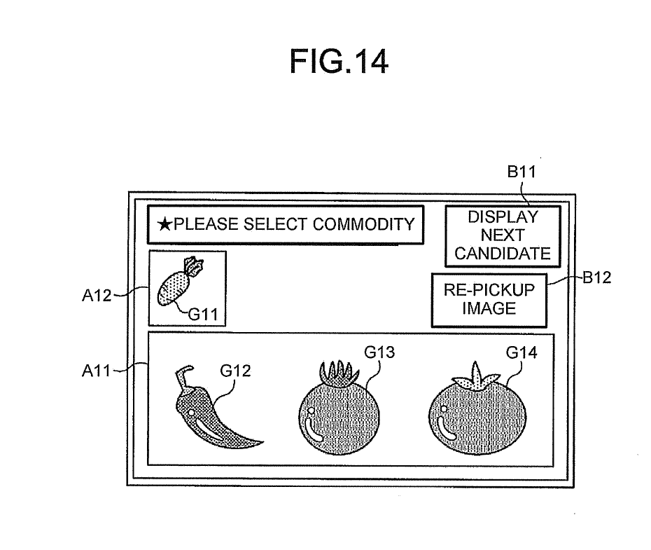

Moreover, the composition of the displayed screen described in the commodity candidate prompt processing is not limited to the examples in FIG. 10-FIG. 13, and further can be in the form of the display region set to be used for displaying other essential elements and an operation button. For instance, as shown in FIG. 14, a button B12 also can be set to be the operational character indicating to reshoot the commodity G. Herein, in the condition that the button B12 is operated, the image data picked-up by the image pick-up section 164 are acquired by returning the processing to act S12 in FIG. 5. Therefore, in the similarity calculation section 1613, the commodity G is recognized again, so as to update the commodity image displayed on the display 106. Therefore, in the condition that the suitable commodity candidate (commodity image) is not displayed, the more suitable commodity candidate (commodity image) can be displayed by operating the button B12 after the image pick-up state (the configuration of the commodity G, the position of the hand and the like) of the commodity G is altered.

Moreover, in the above-described commodity candidate prompt processing, the form of displaying the manual input item with the display termination of all the groups as the requirement is set but is not limited to this. For instance, it can be the form of displaying the manual input item with the display of the second group as the requirement, and further can be the form of displaying the manual input item with the execution (for instance, pressing down a button for displaying the manual input item) of a fixed operation indicating the display of the manual input item as the requirement.

Moreover, in the above-described embodiment, the form that the POS terminal 11 comprises the PLU file F1 is set but is not limited to this, also can be the form that the commodity reading apparatus 101 comprises the PLU file F1, and further can be the form that an external apparatus which can be accessed by the POS terminal 11 and the commodity reading apparatus 101 comprises the PLU file F1.

Moreover, in the above-described embodiment, the composition of the POS terminal 11 and the commodity reading apparatus 101 is set, but not limited to this, and further can be one apparatus comprising the functions of the POS terminal 11 and the commodity reading apparatus 101.

Moreover, the program executed by each apparatus of the embodiment is provided by being previously programmed the storage medium (ROM or storage section) of each apparatus, but not limited to this, and further can be constituted to be provided by recording the program in a computer-readable recording medium such as a CD-ROM, a floppy disk (FD), a CD-R, a DVD (Digital Versatile Disk) and the like by a file in an installable way or an executable way. In addition, the storage medium is not limited to a medium independent form a computer or a constituent system, and also includes the storage medium stored or temporarily stored by downloading the program transmitted through an LAN, the Internet and the like.

Moreover, the program executed by each apparatus of the above-described embodiment further can be constituted to be stored in the computer connected with a network such as the Internet and the like and provided after being downloaded through the network, and also can be constituted to be provided or issued through the network such as the Internet and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A store system, comprising:
an acquisition section configured to acquire an image picked-up by an image pick-up section;
a similarity calculation section configured to calculate a similarity which represents a degree with which the reference image of each commodity is similar to the image of an object picked-up by the image pick-up section;
a display control section configured to display the commodity information of the commodity corresponding to the reference image with a high similarity as a commodity candidate executing registration processing on a display section based on the similarity calculated by the similarity calculation section;
a selection acceptance section configured to accept the selection to the commodity information displayed on the display section; and
a processing section configured to process the object picked-up by the image pick-up section as the commodity corresponding to the selected commodity information accepted by the selection acceptance section.

2. The store system according to claim 1, wherein
the display control section displays a screen including a first display region and a second display region on the display section, displays the present commodity information in the first display region, and displays the commodity information displayed in the first display region until a last time in the second display region.

3. The store system according to claim 2, wherein
the selection acceptance section accepts the selection of one commodity information from the commodity information displayed in the first display region and the second display region.

4. The store system according to claim 2, wherein
the display control section displays the screen including a first operational character indicating the acquisition of the image on the display section; and
the acquisition section acquires a new image picked-up by the image pick-up section when the first operational character is operated.

5. The store system according to claims 1, wherein
the display control section displays a second operational character that is used for manually inputting the selection of the commodity information corresponding to the object on the display section when the condition relevant with the display of the commodity information satisfies a given condition; and
the processing section processes the object picked-up by the image pick-up section as the commodity selected through the second operational character.

6. A method, comprising:
acquiring an image picked-up by an image pick-up section;
calculating a similarity which represents a degree with which the reference image of each commodity is similar to the image of an object picked-up by the image pick-up section;
displaying the commodity information of the commodity corresponding to the reference image with a high similarity as a commodity candidate executing registration processing on a display section based on the similarity;
accepting the selection to the commodity information displayed on a display section; and
processing the object picked-up by the image pick-up section as the commodity corresponding to the selected commodity information.
